(19) United States
(12) Patent Application Publication
(10) Pub. No.: US 2019/0118724 A1
(43) Pub. Date: Apr. 25, 2019

(54) Steering Wheel Wallet Mount

(71) Applicant: Timothy Edward Garner, Lusby, MD (US)

(72) Inventor: Timothy Edward Garner, Lusby, MD (US)

(21) Appl. No.: 16/165,830

(22) Filed: Oct. 19, 2018

Related U.S. Application Data
(60) Provisional application No. 62/574,479, filed on Oct. 19, 2017.

(51) Int. Cl. B60R 7/08; B60R 7/04; B60R 11/00; F16B 2/08

(52) U.S. Cl. CPC B60R 7/087; B60R 7/04; B60R 11/00; A44B 11/04; B60R 2011/001; B60R 2011/0063; F16B 2/08

(57) ABSTRACT

A steering wheel wallet mount for positioning a wallet in easy reach of a user includes an anchoring patch and a wallet patch. The anchoring patch includes a first contact side, a receiving side, a securing mechanism, and a first wallet fastener. The wallet patch includes a second contact side, a concealed side, and a second wallet fastener. The anchoring patch is secured to the steering wheel via the securing mechanism. The first contact side of the anchoring patch presses against the steering wheel. The first wallet fastener is mounted on the receiving side of the anchoring patch and allows the wallet patch to attach thereon. The second wallet fastener is mounted onto the second contact side. Together, the first wallet fastener and the second wallet fastener attach the second contact side to the first contact side. The wallet is mounted onto the concealed side opposite the second contact side.

The current application claims a priority to the U.S. Provisional Patent application Ser. No. 62/574,479 filed on Oct. 19, 2017.

### FIELD OF THE INVENTION

The present invention generally relates to a steering wheel wallet mount for providing a user convenient access to a wallet. More specifically, the present invention employs an anchoring patch releasably mounted on the steering wheel for positioning the wallet in easy reach of the user.

### BACKGROUND OF THE INVENTION

It is a well-known fact that traffic stops can easily escalate into life-or-death situations. Police officers are at a heightened state of alert and are sensitive to the slightest signs of hostility. Likewise, the driver or passenger is also nervous and fearful for his own safety. In such a situation, the driver must clearly communicate his intentions to the officer. Any abrupt and rapid movement can trigger the police to pull his gun. However, it is often necessary to move about the cabin to gather the license documents demanded by the officer. This also conceals the driver's hands from the police officer causing miscommunication and escalating the situation.

Although modern car cabins have several compartments for storing wallets and similar unsecured items, these compartments are usually placed in hard to reach areas such as under the dashboard or in the glove box between the front seats. Alternately, the driver can place the wallet in his back pockets which are equally hard to reach while the driver is sitting in the car. Thus, it is often necessary for the driver or passenger to physically move about the seat to access their wallet. In most instances this is not a problem: when driving the car, the driver isn't permitted to shift his attention from the road. When stopped, the driver is free to move about the cabin and access the hidden compartments. However, in a traffic stop this can surprise the police officer and escalate the situation.

Accordingly, the present invention is designed to position a wallet in easy reach of the driver while the driver is in the car. As such, the driver can access the wallet for necessary documents while keeping his hands in view of the officer. To achieve this, the present invention utilizes an anchoring patch which is anchored to the steering wheel via a pair of straps. The pair of straps is length-adjustable and can be lengthened or shortened depending on the size of the steering wheel. A wallet patch is permanently mounted onto a wallet, allows the wallet to be attached to the front of the anchoring patch. This positions the wallet in front of the steering wheel in easy reach of the driver, thereby allowing the driver to open the wallet while keeping his hands completely exposed.

### BRIEF DESCRIPTION OF THE DRAWINGS

FIG. 1 is a front view of the present invention illustrating the wallet patch detached from the anchoring patch.

FIG. 2 is a rear view of the present invention illustrating the first contact side of the anchoring patch.

FIG. 3 is a front view of the wallet illustrating the concealed side of the wheel patch.

FIG. 4 is a detail view of the first wheel strap illustrating the snap-locking prong engaged to the frame.

FIG. 5 is a detail view of the second wheel strap illustrating the snap-locking prong disengaged from the frame.

FIG. 6 is a rear view of an alternate embodiment of the anchoring patch, illustrating the plurality of adhesive straps perimetrically connected to the first contact side.

### DETAILED DESCRIPTION OF THE INVENTION

All illustrations of the drawings are for the purpose of describing selected versions of the present invention and are not intended to limit the scope of the present invention.

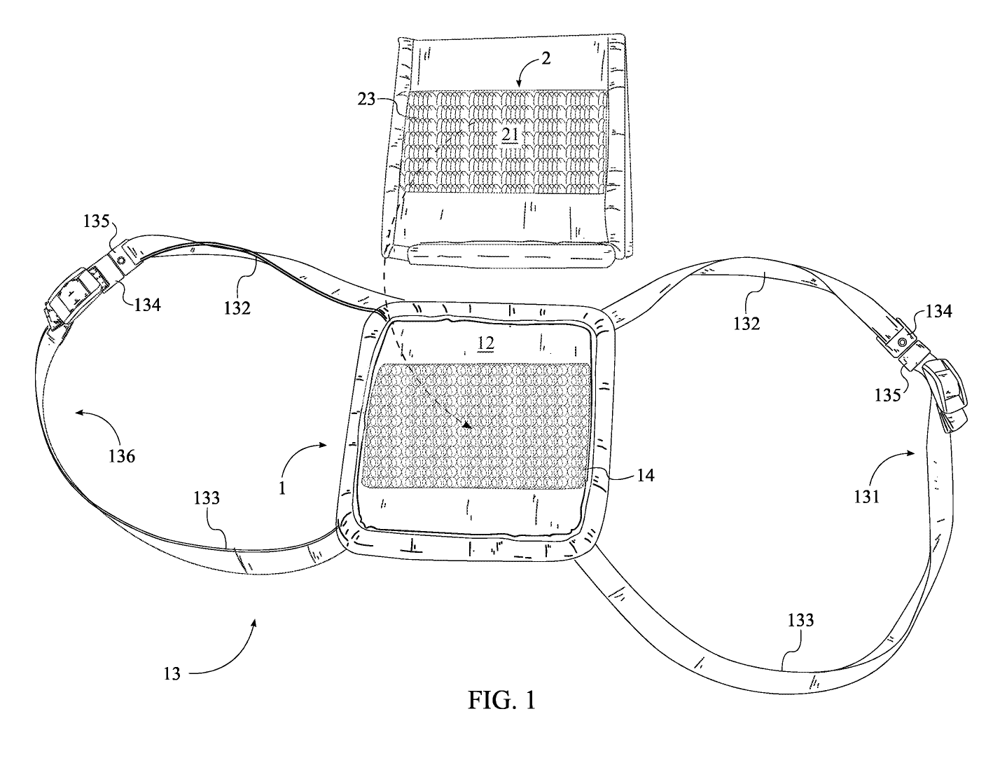

The present invention is a steering wheel wallet mount that gives users convenient access to their wallet inside the cabin of a car. The preferred embodiment of the present invention attaches the wallet to the airbag cover of the steering wheel. This allows a user to quickly access the wallet without having to reach into pockets or glove boxes in the car. As can be seen in FIG. 1, the preferred embodiment of the present invention comprises an anchoring patch 1 and a wallet patch 2. The anchoring patch 1 anchors the wallet patch 2 to the front of the steering wheel. Accordingly, the anchoring patch 1 and the wallet patch 2 attach to each other via hook and loop fasteners, adhesive strips, and/or magnets. Preferably, both the anchoring patch 1 and the wallet patch 2 are made of synthetic fabrics such as nylon, polyester, PVC fabric. Alternately, the anchoring patch 1 and the wallet patch 2 may be made of flexible or high-density plastics.

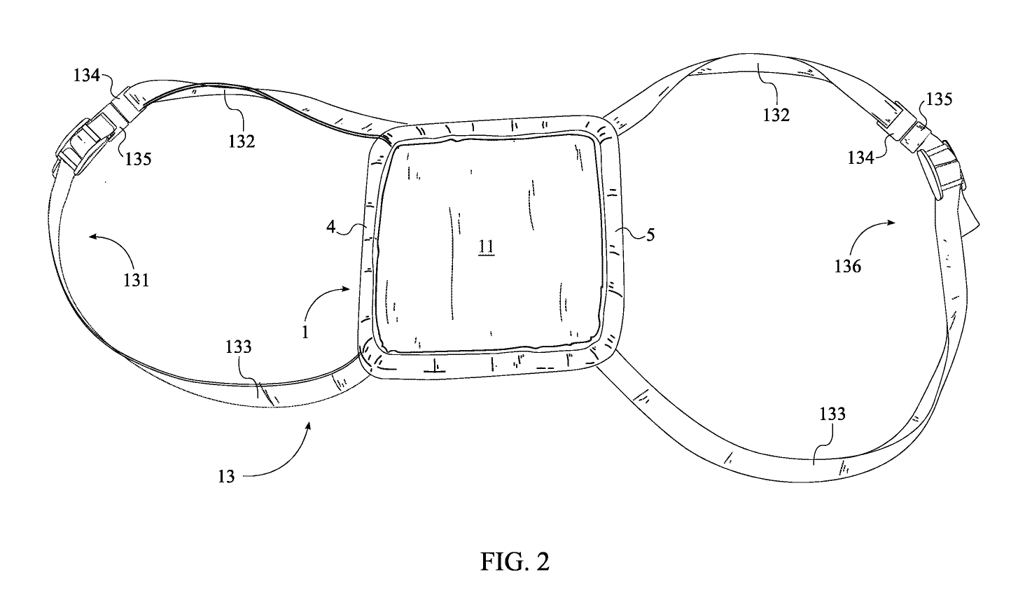

Referring to FIG. 1 and FIG. 2, the anchoring patch 1 comprises a first contact side 11, a receiving side 12, a securing mechanism 13, and a first wallet fastener 14. The securing mechanism 13 secures the first contact side 11 against the airbag cover of the steering wheel. Once attached, the first contact side 11 faces away from the user and is thus concealed under the anchoring patch 1. In contrast, the receiving side 12 faces towards the user and allows the wallet to mount thereon. Accordingly, the first contact side 11 and the receiving side 12 are positioned opposite of each other about the anchoring patch 1. Further, the first wallet fastener 14 is laterally mounted on the receiving side 12. As such, the wallet patch 2 is attached to the receiving side 12 of the anchoring patch 1 by the first wallet fastener 14. In one possible embodiment, the first wallet fastener 14 may be a hook or loop portion of a hook-and-loop fastener. Alternately, the first wallet fastener 14 may also be magnets, adhesives, or mechanical fasteners such as snaps.

In the preferred embodiment, the anchoring patch 1 is deflected by the airbag cover in the case of an airbag deployment. As such, the anchoring patch 1 is designed to be ejected away from the airbag cover as the airbag deploys. More specifically, the force of the deployment unfastens the securing mechanism 13 thereby allowing the anchoring patch 1 to be ejected along with the airbag cover, allowing the airbag to expand freely. The preferred securing mechanism 13 is perimetrically connected around the first contact side 11. In one possible embodiment, the securing mechanism 13 may be a plurality of length-adjustable straps that wrap around the spokes of the steering wheel. In another possible embodiment, the securing mechanism 13 may be a plurality of adhesive strips that stick onto the airbag cover, thereby fastening the anchoring patch 1.

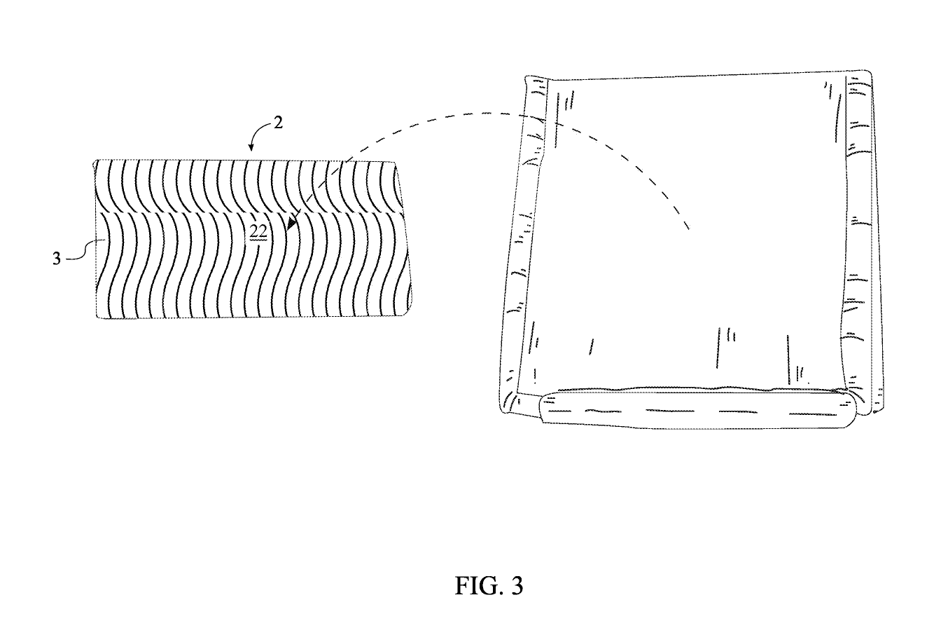

Referring to FIG. 1 and FIG. 3, the preferred wallet patch 2 comprises a second contact side 21, a concealed side 22, and a second wallet fastener 23. The second contact side 21 contacts the receiving side 12 of the anchoring patch 1. Accordingly, the second contact side 21 and the concealed side 22 are positioned opposite each other about the wallet patch 2. As such, the second contact side 21 and the attached second wallet fastener 23 are oriented towards the receiving side 12 of the anchoring patch 1. In contrast, the concealed side 22 faces away from the anchoring patch 1. This allows the wallet to be mounted onto the concealed side 22 which completely covers the concealed side 22. Preferably, the wallet patch 2 is permanently mounted onto the wallet and thus may not be separated. As such, in one possible embodiment, an adhesive coating may be applied to the concealed side that permanently connects the wallet to the wallet patch 2. In contrast, the second wallet fastener 23 releasably attaches the wallet patch 2 to the anchoring patch 1. Preferably, the second wallet fastener 23 is laterally mounted onto the second contact side 21, opposite the concealed side 22. Further, the second wallet fastener 23 is laterally attached onto the first wallet fastener 14. This attaches the wallet to the anchoring patch 1. In one possible embodiment, the second wallet fastener 23 may be the hook or loop portion of the hook-and-loop fastener. Alternately, the second contact side 21 may be adhesives, magnets, and/or mechanical fasteners such as snaps. Alternately, the edges of the concealed side 22 may be sewn onto the outer surface of the wallet for the same effect.

Referring back to FIG. 2, in a possible embodiment of the present invention, the securing mechanism 13 comprises a first wheel strap 131 and a second wheel strap 136. The first wheel strap 131 and the second wheel strap 136 are perimetrically connected to the first contact side 11. Both the first wheel strap 131 and the second wheel strap 136 comprises nylon or polyester strips that can selectively attach to each other. In case the airbag deploys, the strips are designed to detach to allow the airbag to expand freely. Preferably, both the first wheel strap 131 and the second wheel strap 136 are sewn onto the corners of the anchoring patch 1. Thus, as the anchoring patch 1 is deflected, the first wheel strap 131 and the second wheel strap 136 are pulled apart by the force of deployment. The spokes are positioned on opposite sides of the steering wheel. As such, the first wheel strap 131 and the second wheel strap 136 are positioned opposite each other about the first contact side 11. This allows the first wheel strap 131 and the second wheel strap 136 to wrap around a spoke of the steering wheel coming out of the hub. Depending on the size of the spokes, the lengths of the first wheel strap 131 and the second wheel strap 136 can be adjusted to ensure a secure fit with the respective spoke.

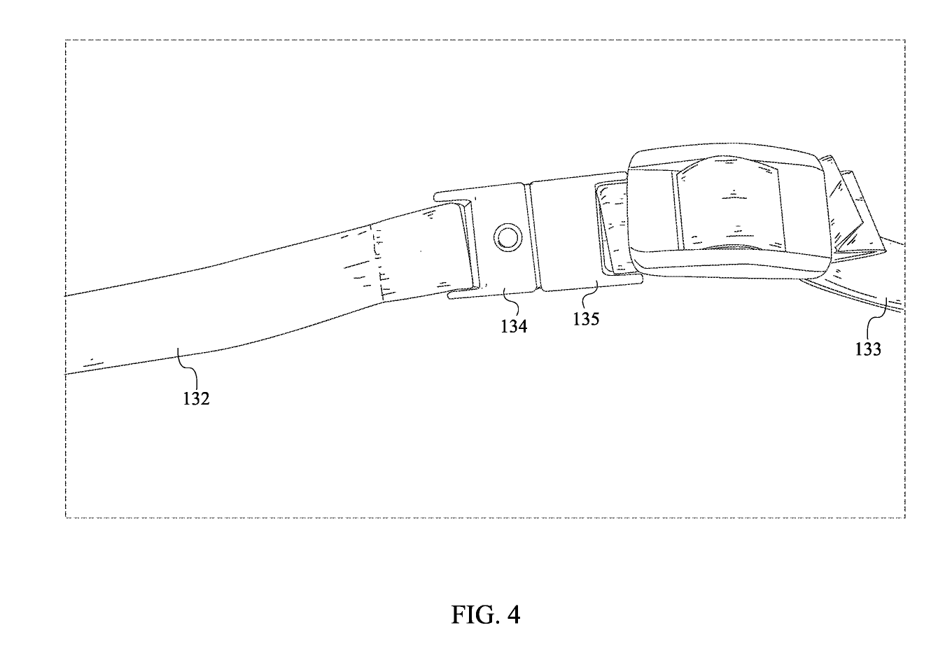

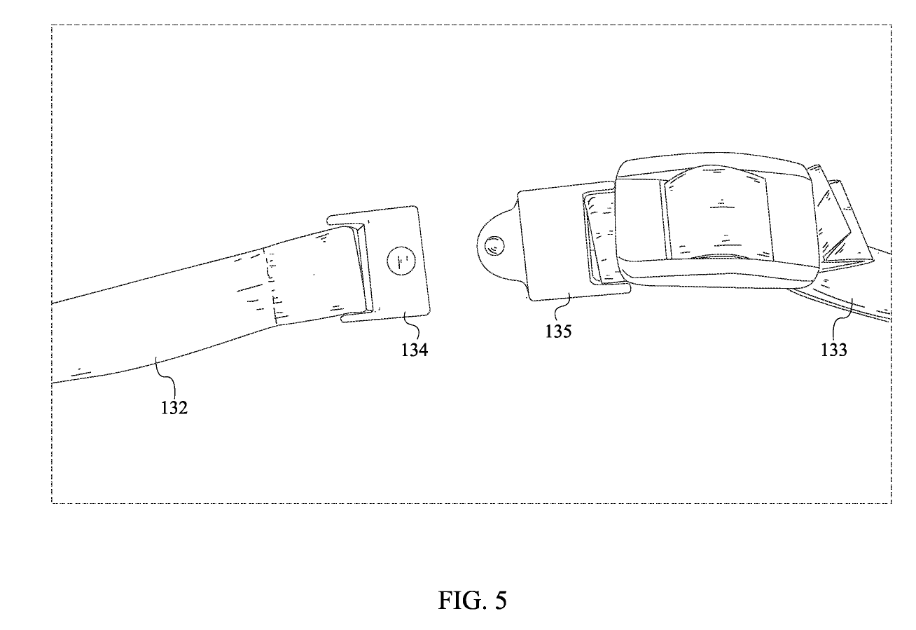

Referring to FIG. 2, FIG. 4, and FIG. 5, in the preceding embodiment, the first wheel strap 131 comprises a fixed portion 132, an adjustable portion 133, a frame 134, and a snap-locking prong 135. The fixed portion 132 of the first wheel strap 131 has a fixed length and is not adjustable. In contrast, the length of the adjustable portion 133 of the first wheel strap 131 can be adjusted depending on the size of the spokes. The anchoring patch 1 further comprises a first joining edge 4 and a second joining edge 5. The first joining edge 4 and the second joining edge 5 are positioned opposite each other about the first contact side 11. As the name implies, the first wheel strap 131 is connected across the first joining edge 4. More specifically, the fixed portion 132 of the first wheel strap 131 is terminally connected to the first joining edge 4. Similarly, the adjustable portion 133 of the first wheel strap 131 is terminally connected to the first joining edge 4. Further, the fixed portion 132 and the adjustable portion 133 of the first wheel strap 131 are connected opposite each other about the first joining edge 4. This allows the first wheel strap 131 to extend across the of the anchoring patch 1. The frame 134 and the snap-locking prong 135 allow the fixed portion 132 and the adjustable portion 133 of the first wheel strap 131 to connect to each other. Preferably, the frame 134 acts as the female end which receives the snap-locking prong 135. Once inserted into the frame 134, the snap-locking prong 135 snaps onto the frame 134 thereby creating a secure engagement. To release the snap-locking frame 134, the snap-locking frame 134 is simply pulled with force. Preferably, the snap-locking frame 134 is terminally and slidably engaged to the adjustable portion 133 of the first wheel strap 131. Alternately, the frame 134 is terminally connected to the fixed portion 132 of the first wheel strap 131. To adjust the length of the first wheel strap 131, the adjustable portion 133 may be lengthened or shortened while the snap-locking prong 135 is engaged to the frame 134. Preferably, the second wheel strap 136 is identical to the first wheel strap 131.

Thus, the second wheel strap 136 comprises a fixed portion 132, an adjustable portion 133, a frame 134, and a snap-locking prong 135. However, unlike the first wheel strap 131, the fixed portion 132 of the second wheel strap 136 is terminally connected to the second joining edge 5. Further, the adjustable portion 133 of the second wheel strap 136 is terminally connected to the second joining edge 5. Accordingly, the first wheel strap 131 and the second wheel strap 136 are positioned opposite each other about the first contact side 11. Further, the fixed portion 132 of the second wheel strap 136 and the adjustable portion 133 of the second wheel strap 136 are connected opposite each other about the second joining edge 5. Finally, the snap-locking prong 135 is terminally and slidably engaged to the adjustable portion 133 of the second wheel strap 136. The frame 134 is terminally connected to the fixed portion 132 of the second wheel strap 136. This allows the fixed portion 132 and the adjustable portion 133 of the second wheel strap 136 to selectively engage one another.

Referring back to FIG. 1, in one possible embodiment, the first wallet fastener 14 is a hook portion of a hook and loop fastener, and the second wallet fastener 23 is a loop portion of the hook and loop fastener. Accordingly, the first wallet fastener 14 can releasably attach to the second wallet fastener 23. Preferably, the the first wallet fastener 14 can be easily pulled off the second wallet fastener 23. Further, interchanging the hook portion and the loop portion still allows the first wallet fastener 14 to attach to the second wallet fastener 23. As such, in an alternate embodiment, the first wallet fastener 14 is a loop portion of a hook and loop fastener, and the second wallet fastener 23 is a hook portion of the hook and loop fastener. In yet another embodiment, the first wallet fastener 14 and the second wallet fastener 23 may be magnets, adhesives, snaps, and/or like fastening mechanisms.

Referring to FIG. 3, in one possible embodiment, an adhesive coating 3 allows the wallet patch 2 to be permanently attached to the wallet. Accordingly, the adhesive coating 3 is superimposed onto the concealed side 22 of the wallet patch 2. As such, once the wallet patch 2 is mounted to the wallet, the concealed side 22 is completely concealed under the wallet, whereas the second contact side 21 remains visible on the opposite side of the wallet patch 2. The adhesive coating 3 is strong enough to permanently mount the wallet patch 2 to the wallet. Before the wallet patch 2 is mounted to the wallet, the adhesive coating 3 may be covered with a thin plastic film that protects the adhesive coating 3 from premature exposure to dirt, dust, or other potential contaminants. The plastic film also prevents the adhesive coating 3 from drying out before being utilized. Before mounting the wallet patch 2 to the wallet, the user can simply remove and dispose the plastic film. Preferably, the wallet patch 2 is permanently mounted to the wallet and is fixed in place. Further, the wallet patch 2 is mounted on the rear surface of the wallet, allowing the user to open and access the wallet.

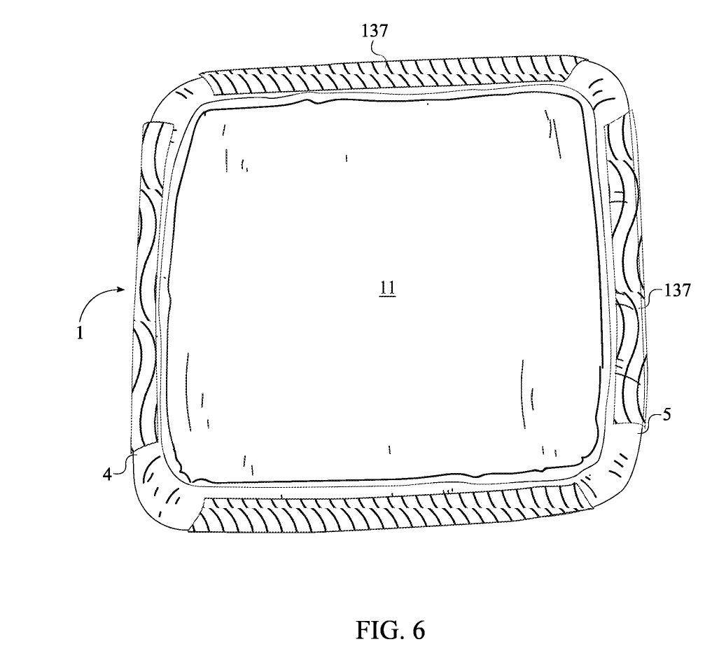

Referring to FIG. 6, in a possible embodiment of the present invention, the securing mechanism 13 comprises a plurality of adhesive strips 137. The plurality of adhesive strips 137 allows the anchoring patch 1 to releasably attach to the airbag cover. Further, the plurality of adhesive strips 137 obviates the need to attach the anchoring patch 1 to the spokes of the steering wheel. Instead, the plurality of adhesive strips 137 allows the anchoring patch 1 to be mounted directly to the airbag cover. Accordingly, when the airbag deploys, the anchoring patch 1 remains attached to the airbag cover and is deflected out of the path of the airbag. To securely attach the anchoring patch 1 to the airbag cover, the plurality of adhesive strips 137 is perimetrically attached around the first contact side 11. Each of the plurality of adhesive strips 137 is a plastic strip coated with a medium-strength adhesive. This allows the user to detach the anchoring patch 1 from the steering wheel, as required. For example, each of the plurality of adhesive strips 137 may be coated with a pressure sensitive adhesive such as acrylic adhesives, epoxy resins, rubber-based adhesives, silicone adhesives, or polyurethane and isocyanate adhesives.

In yet another embodiment of the present invention, the securing mechanism 13 may secure the anchoring patch 1 to the arms of the user. As such, the securing mechanism 13 comprises a first arm band and a second arm band. The first arm band is preferably connected to the first contact side 11. Alternately, the second arm band is connected to the first contact side 11, opposite the first arm band.

Further, the first arm band comprises a first overlapping side. The second arm band comprises a second overlapping side. A hook portion of a hook-and-loop fastener is laterally connected onto the first overlapping side. Further, a loop portion of the hook-and-loop fastener is laterally connected onto the second overlapping side. This allows the first overlapping side to attach to the second overlapping side.

Although the invention has been explained in relation to its preferred embodiment, it is to be understood that many other possible modifications and variations can be made without departing from the spirit and scope of the invention as hereinafter claimed.

What is claimed is:

1. A steering wheel wallet mount comprises:
an anchoring patch;
a wallet patch;
the anchoring patch comprises a first contact side, a receiving side, a securing mechanism, and a first wallet fastener;
the wallet patch comprises a second contact side, a concealed side, and a second wallet fastener;
the first contact side and the receiving side being positioned opposite of each other about the anchoring patch;
the first wallet fastener being laterally mounted onto the receiving side;
the securing mechanism being perimetrically connected around the first contact side;
the second contact side and the concealed side being positioned opposite of each other about the wallet patch;
the second wallet fastener being laterally mounted onto the second contact side, opposite the concealed side; and
the second wallet fastener being laterally attached onto the first wallet fastener.

2. The steering wheel wallet mount as claimed in claim 1 comprises:
the securing mechanism comprises a first wheel strap and a second wheel strap;
the first wheel strap and the second wheel strap being perimetrically connected to the first contact side; and
the first wheel strap and the second wheel strap being positioned opposite each other about the first contact side.

3. The steering wheel wallet mount as claimed in claim 2 comprises:
the first wheel strap comprises a fixed portion, an adjustable portion, a frame, and a snap-locking prong;
the anchoring patch further comprises a first joining edge and a second joining edge;
the first joining edge and the second joining edge being positioned opposite each other about the first contact side;
the fixed portion being terminally connected to the first joining edge;
the adjustable portion being terminally connected to the first joining edge;
the fixed portion and the adjustable portion being connected opposite each other about the first joining edge;
the snap-locking prong being terminally and slidably engaged to the adjustable portion; and
the frame being terminally connected to the fixed portion.

4. The steering wheel wallet mount as claimed in claim 2 comprises:
the second wheel strap comprises a fixed portion, an adjustable portion, a frame, and a snap-locking prong;
the anchoring patch further comprises a first joining edge and a second joining edge;
the first joining edge and the second joining edge being positioned opposite each other about the first contact side;
the fixed portion being terminally connected to the second joining edge;
the adjustable portion being terminally connected to the second joining edge;
the fixed portion and the adjustable portion being connected opposite each other about the second joining edge;
the snap-locking prong being terminally and slidably engaged to the adjustable portion; and
the frame being terminally connected to the fixed portion.

5. The steering wheel wallet mount as claimed in claim 1, wherein the first wallet fastener is a hook portion of a hook and loop fastener, and wherein the second wallet fastener is a loop portion of the hook and loop fastener.

6. The steering wheel wallet mount as claimed in claim 1, wherein the first wallet fastener is a loop portion of a hook and loop fastener, and wherein the second wallet fastener is a hook portion of the hook and loop fastener.

7. The steering wheel wallet mount as claimed in claim 1 comprises:
an adhesive coating; and
the adhesive coating being superimposed onto the concealed side of the wallet mount.

8. The steering wheel wallet mount as claimed in claim 1 comprises:
the securing mechanism comprises a plurality of adhesive strips; and
the plurality of adhesive strips being perimetrically attached around the first contact side.

9. A steering wheel wallet mount comprises:
an anchoring patch;
a wallet patch;
the anchoring patch comprises a first contact side, a receiving side, a securing mechanism, and a first wallet fastener;
the wallet patch comprises a second contact side, a concealed side, and a second wallet fastener;
the securing mechanism comprises a first wheel strap and a second wheel strap;
the first contact side and the receiving side being positioned opposite of each other about the anchoring patch;
the first wallet fastener being laterally mounted onto the receiving side;
the securing mechanism being perimetrically connected around the first contact side;
the second contact side and the concealed side being positioned opposite of each other about the wallet patch;
the second wallet fastener being laterally mounted onto the second contact side, opposite the concealed side;
the second wallet fastener being laterally attached onto the first wallet fastener;
the first wheel strap and the second wheel strap being perimetrically connected to the first contact side; and
the first wheel strap and the second wheel strap being positioned opposite each other about the first contact side.

10. The steering wheel wallet mount as claimed in claim 9 comprises:
the first wheel strap comprises a fixed portion, an adjustable portion, a frame, and a snap-locking prong;
the anchoring patch further comprises a first joining edge and a second joining edge;
the first joining edge and the second joining edge being positioned opposite each other about the first contact side;
the fixed portion being terminally connected to the first joining edge;
the adjustable portion being terminally connected to the first joining edge;
the fixed portion and the adjustable portion being connected opposite each other about the first joining edge;
the snap-locking prong being terminally and slidably engaged to the adjustable portion; and
the frame being terminally connected to the fixed portion.

11. The steering wheel wallet mount as claimed in claim 9 comprises:
the second wheel strap comprises a fixed portion, an adjustable portion, a frame, and a snap-locking prong;
the anchoring patch further comprises a first joining edge and a second joining edge;
the first joining edge and the second joining edge being positioned opposite each other about the first contact side;
the fixed portion being terminally connected to the second joining edge;
the adjustable portion being terminally connected to the second joining edge;
the fixed portion and the adjustable portion being connected opposite each other about the second joining edge;
the snap-locking prong being terminally and slidably engaged to the adjustable portion; and
the frame being terminally connected to the fixed portion.

12. The steering wheel wallet mount as claimed in claim 9, wherein the first wallet fastener is a hook portion of a hook and loop fastener, and wherein the second wallet fastener is a loop portion of the hook and loop fastener.

13. The steering wheel wallet mount as claimed in claim 9, wherein the first wallet fastener is a loop portion of a hook and loop fastener, and wherein the second wallet fastener is a hook portion of the hook and loop fastener.

14. The steering wheel wallet mount as claimed in claim 9 comprises:
an adhesive coating; and
the adhesive coating being superimposed onto the concealed side of the wallet mount.

15. The steering wheel wallet mount as claimed in claim 9 comprises:
the securing mechanism comprises a plurality of adhesive strips; and
the plurality of adhesive strips being perimetrically attached around the first contact side.
